(19) United States
(12) Patent Application Publication
(10) Pub. No.: US 2011/0254878 A1
(43) Pub. Date: Oct. 20, 2011

(54) IMAGE PROCESSING APPARATUS

(75) Inventors: Hirofumi MORI, Fuchu-shi (JP); Masami MORIMOTO, Fuchu-shi (JP)

(73) Assignee: KABUSHIKI KAISHA TOSHIBA, Tokyo (JP)

(21) Appl. No.: 13/090,143

(22) Filed: Apr. 19, 2011

(30) Foreign Application Priority Data
Apr. 19, 2010 (JP) 2010-096268

(51) Int. Cl. G09G 5/10

(52) U.S. Cl. 345/690

(57) ABSTRACT

According to one embodiment, an image processing apparatus includes a panel luminance controller, a calculation module and a conversion module. The panel luminance controller is configured to control panel luminance of a self-emission type device based on intensity of ambient light. The calculation module is configured to calculate a gradation conversion function based on a characteristic amount of an input image and the panel luminance, the gradation conversion function having been provided to correct appearance of the input image. The conversion module is configured to apply the gradation conversion function to the input image, to generate an output image.

### CROSS-REFERENCE TO RELATED APPLICATIONS

This application is based upon and claims the benefit of priority from Japanese Patent Application No. 2010-096268, filed Apr. 19, 2010, the entire contents of which are incorporated herein by reference.

### FIELD

Embodiments described herein relate generally to a technique of processing images.

### BACKGROUND

Human visual sensation is known to perceive the same color as different, depending on the intensity of ambient light. CIE Publication No 159, “A colour appearance model for colour management systems: CIECAM02” discloses a color management method based on “colour appearance models.” Further, a technique is known, which controls panel luminance, gradation value, etc., in accordance with the ambient light, thereby to make images appear constant. Jpn. Pat. Appln. KOKAI Publication No. 2005-300639, for example, describes a technique of controlling an image display apparatus in accordance with the color appearance index calculated from illumination conditions.

In a self-emission type device, such as an organic light emitting diode (OLED) display, the power consumption of display greatly changes with the display content (e.g., the luminance of the image displayed). Jpn. Pat. Appln. KOKAI Publication No. 2007-147868 describes a technique of controlling the peak luminance in accordance with the average gradation value, for example luminance signals, thereby to suppress the current consumption of the OLED display or render the same constant. Jpn. Pat. Appln. KOKAI Publication No. 2009-300517 describes a technique of suppressing the peak luminance and expanding the dynamic range for dark scenes, thereby enhancing the gradation appearance, and of restoring the contrast of frequently used gradations at bright scene, thereby to prevent the subjective contrast from lowering and to reduce the current consumption.

Another technique is known, which controls panel luminance, gradation values, etc., in accordance with the ambient light, thereby to sustain the color appearance. Also known is a technique of controlling the peak luminance in accordance with the characteristic amount of an image (e.g., average picture level (APL)), thereby to suppress the current consumption. However, no specific proposals have been made for combining these techniques. If these techniques are merely combined, the current consumption may be suppressed too much, inevitably degrading the subjective image quality greatly, or the subjective image quality may be maintained, inevitably failing to suppress the current consumption sufficiently.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a cellular phone having an image processing function associated with an image processing apparatus according a first embodiment;

FIG. 2 is a flowchart showing the process performed by the image processing apparatus according the first embodiment;

FIG. 3 is a flowchart showing the process performed in Step S006 shown in FIG. 2;

FIG. 4 is a flowchart showing the process performed in Step S108 shown in FIG. 3;

FIG. 5 is a flowchart showing the process performed in Step S203 shown in FIG. 4;

FIG. 6 is a diagram explaining a process for expanding the dynamic range of ideal panel characteristics;

FIG. 7 is a graph representing the relation between APL and gain;

FIG. 8 is a histogram of gradation values;

FIG. 9 shows a part of the histogram shown in FIG. 8;

FIG. 10 shows another part of the histogram shown in FIG. 8;

FIG. 11 is a diagram explaining a process of generating a gradation correction function;

FIG. 12 is another diagram explaining a process of generating a gradation correction function;

FIG. 13 is a block diagram showing the image processing apparatus according to the first embodiment;

FIG. 14 is a block diagram showing an image processing apparatus according to a second embodiment; and

FIG. 15 is a graph representing the relations an average picture level (APL) and a corrected gain may have under various circumstances.

### DETAILED DESCRIPTION

Various embodiments will be described hereinafter with reference to the accompanying drawings.

In general, according to one embodiment, an image processing apparatus includes a panel luminance controller, a calculation module and a conversion module. The panel luminance controller is configured to control panel luminance of a self-emission type device based on intensity of ambient light. The calculation module is configured to calculate a gradation conversion function based on a characteristic amount of an input image and the panel luminance, the gradation conversion function having been provided to correct appearance of the input image. The conversion module is configured to apply the gradation conversion function to the input image, to generate an output image.

### First Embodiment

An image processing apparatus according to a first embodiment is implemented as a processor, such as a central processing unit (CPU) that is incorporated in a data processing apparatus such as a cellular phone. The processor executes a program to function as the image processing apparatus. The following description is based on the assumption that an image processing function corresponding to the image processing apparatus according to this embodiment is achieved as the controller incorporated in a cellular phone executes a program. Nonetheless, the image processing apparatus according to this embodiment may be implemented, either in part or entirety, by a hardware component such as a digital circuit.

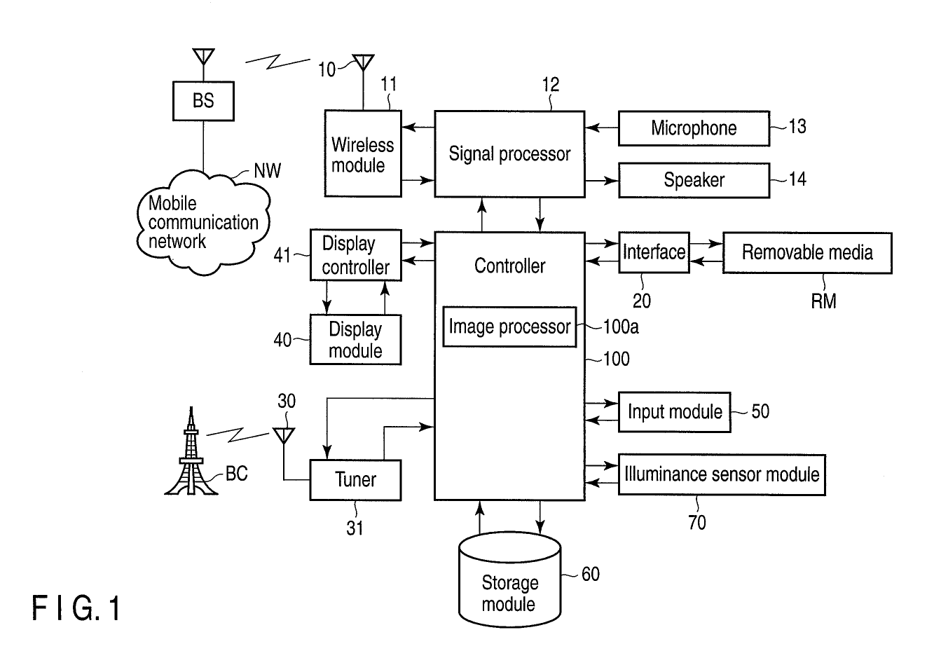

As shown in FIG. 1, the cellular phone has an antenna 10, a wireless module 11, a signal processor 12, a microphone 13, a speaker 14, an interface 20, an antenna 30, a tuner 31, a display module 40, a display controller 41, an input module 50, a storage module 60, an illuminance sensor module 70, and a controller 100.

The wireless module 11 receives a baseband signal transmitted from the signal processor 12 and upconverts the baseband signal to a transmission signal in the radio-frequency (RF) band in accordance with a command coming from the controller 100. The RF transmission signal is transmitted from the antenna 10. The signal transmitted from the antenna 10 is received by a base station BS provided in a mobile communication network NW. Further, the wireless module 11 receives an RF signal from the base station BS through the antenna 10 and downconverts the RF reception signal to a baseband signal. The baseband signal is input to the signal processor 12. Still further, the wireless module 11 may perform filtering and power amplification in a transmission process, and may perform filtering and low-noise amplification in a reception process.

In accordance with a command coming from the controller 100, the signal processor 12 modulates the carrier wave based on data to transmit, thereby generating a baseband transmission signal. The baseband transmission signal is input to the wireless module 11. To accomplish voice communication, a voice signal generated by the microphone 13 is encoded, generating voice data. The voice data, thus generated, is processed as transmission data. On the other hand, to receive video data by streaming, the control data, which should be transmitted to the source of the moving-picture data in order to receive the encoded stream, is processed as the above-mentioned transmission data. Note that the control data is input from the controller 100. The video data is multiplexed in the encoded stream.

Moreover, the signal processor 12 receives a baseband reception signal from the wireless module 11, generating reception data. In order to accomplish voice communication, the signal processor 12 demodulates the reception signal, generating a voice signal. The voice signal is supplied to the speaker 14, which generates sound from the voice signal. In order to receive video data by streaming, the signal processor 12 decodes the encoded stream from the reception data and inputs the encoded stream to the controller 100.

The interface 20 connects a recording medium, e.g., removable media RM, to the controller 100, both physically and electrically. The interface 20 is used, achieving data exchange between the recording medium and the controller 100. The recording medium may store encoded streams. The tuner 31 receives a TV broadcast signal coming from a broadcasting station BC through the antenna 30 and decodes an encoded stream from the TV broadcast signal. The encoded stream is input from the turner 32 to the controller 100.

The display module 40 is, for example, a self-emission type device, such as an OLED display. The display module 40 can display content such as videos, still images, and Web browser. Note that the current consumption of any self-emission type device greatly changes, depending on the content it displays. The display controller 41 controls the display module 40 in accordance with a command coming from the controller 100. The display controller 41 causes the display module 40 to display the image represented by the display data input from the controller 100.

The input module 50 has input devices such as a plurality of key switches (e.g., numeric keypad) and a touch panel. The input module 50 is a user interface that receives requests from the user via the input device.

The storage module 60 is a recording medium, such as a semiconductor storage medium, e.g., random access memory (RAM), read-only memory (ROM), or a magnetic storage medium such as a hard disk. The storage module 60 stores the control programs and control data for the controller 100, and various data items the user has created (e.g., telephone directory data). The storage module 60 may further store the encoded streams the tuner 31 has received, and the control data for storing encoded streams into a removable media RM.

The illuminance sensor module 70 includes an illuminance sensor configured to detect the ambient illuminance. As in most cases, the illuminance sensor incorporates a photoelectric transducer such as a phototransistor or a photodiode. The illuminance sensor module 70 inputs a quantitative value of the ambient illuminance (in lexes [Lx], for example) to the controller 100. The illuminance sensor module 70 may be replaced by a sensor module to detect any other index that represents the intensity of the ambient light.

The controller 100 includes a processor such as a CPU. The controller 100 controls the other components of the cellular phone shown in FIG. 1. More precisely, the controller 100 controls voice communication, reception of TV broadcast programs, and reception of streamed content, in part or entirety. Further, the controller 100 may have a function of decoding the video data multiplexed in an encoded stream obtained by receiving the TV broadcast program, streaming, or reading the storage module 60. The controller 100 further has an image processing function 100a corresponding to the image processing apparatus according to this embodiment. The image processing function 100a is implemented as the processor provided in the controller 100 operates in accordance with the program and control data stored in, for example, the storage module 60. In the following description, “image processing function 100a” and “image processing apparatus 100a” shall be used in the same or similar sense.

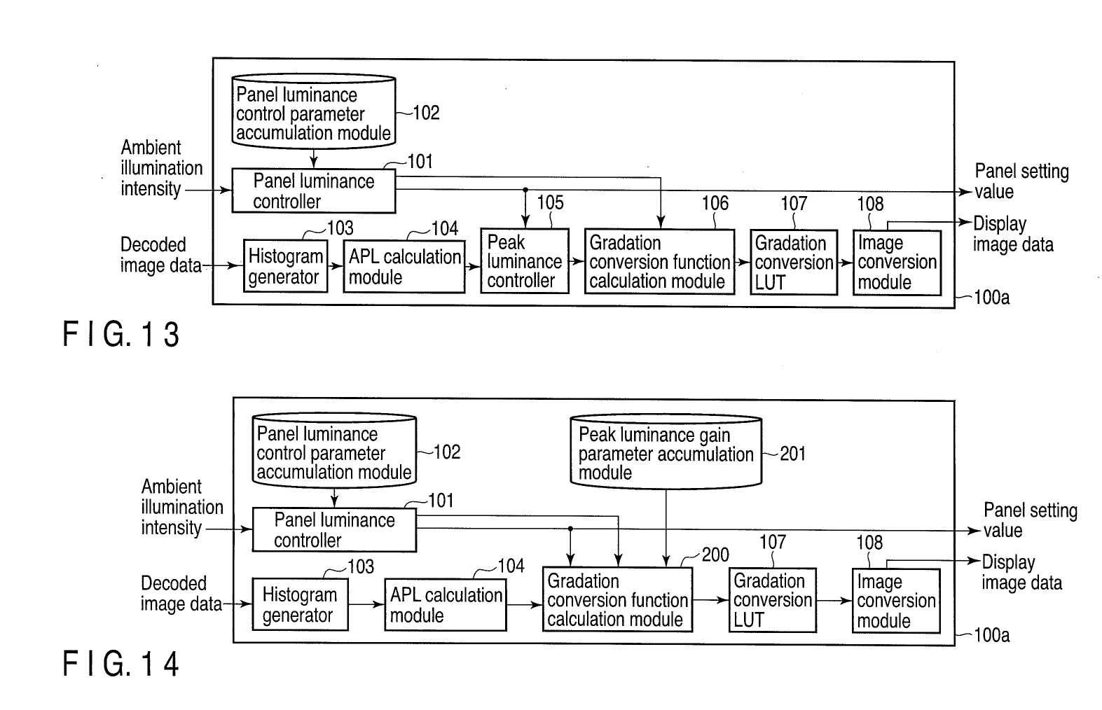

As shown in FIG. 13, the image processing apparatus 100a has a panel luminance controller 101, a panel luminance control parameter accumulation module 102, a histogram generator 103, an APL calculation module 104, a peak luminance controller 105, a gradation conversion function calculation module 106, a gradation conversion lookup table (LUT) storage module 107, and an image conversion module 108. The panel luminance controller 101, histogram generator 103, APL calculation module 104, peak luminance controller 105, gradation conversion function calculation module 106 and image conversion module 108 are, for example, software modules implemented by the processor provided in the controller 100. The panel luminance control parameter accumulation module 102 and gradation conversion LUT storage module 107 are implemented, for example, by storage module, such as storage module 60 that the processor can access.

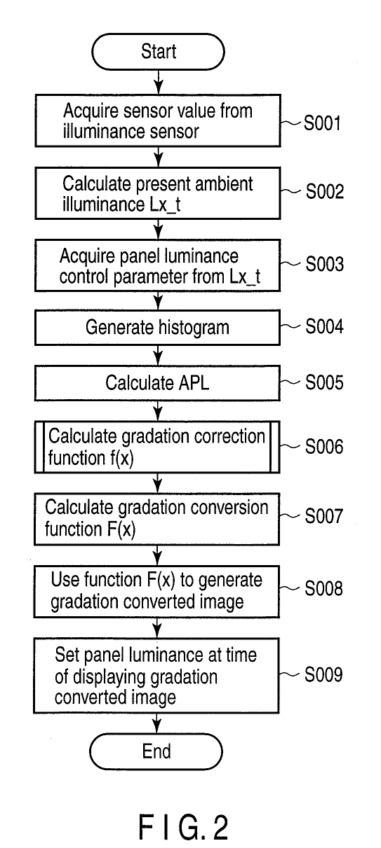

The processes the image processing apparatus 100a performs will be explained with reference to the flowchart of FIG. 2. The sequence of steps shown in FIG. 2 is no more than an example. That is, two or more steps may be performed in parallel unless they depend on one another, or they may be performed in any order other than the order specified in FIG. 2.

In Step S001, the panel luminance controller 101 acquires a sensor value Lx(t) from the illuminance sensor module 70. Step S001 may be repeated at intervals. For example, it may be performed in synchronism with the frame rate (15 Hz, 30 Hz, etc.) of the decoded image that the image processing apparatus 100a may process. Alternatively, it may be performed in synchronism with a multiple (e.g., twice) of the frame rate. It may be performed in synchronism with a constant cycle independent of the frame rate.

Then, in Step S002, the panel luminance controller 101 calculates the present ambient illuminance Lx₌t from the sensor value Lx(t) acquired in Step S001. More specifically, the panel luminance controller 101 may directly use the sensor value Lx(t) or use the average of the sensor values Lx(t) acquired in the past, as present ambient illuminance Lx₌t. The method of calculating the present ambient illuminance Lx₌t may be switched, from one to another, in accordance with the difference between the ambient illuminance Lx₌t calculated in the preceding period and the sensor value Lx(t) acquired at present. That is, if the above-mentioned difference is smaller than a prescribed threshold value TH₌lx, the ambient light is considered not to have changed greatly. In this case, the panel luminance controller 101 can use the average of the sensor values Lx(t) acquired in the past as present ambient illuminance Lx₌t. If the difference is greater than or equal to the prescribed threshold value TH₌lx, the ambient light is considered to have changed greatly. In this case, the sensor value Lx(t) may be used as present ambient illuminance Lx₌t.

Next, the panel luminance controller 101 acquires the panel luminance control parameter corresponding to the present ambient illuminance Lx₌t calculated in Step S002 from the panel luminance control parameter accumulation module 102 (Step S003). The panel luminance parameter contains two parameters, i.e., panel luminance PL(Lx) and gradation conversion γ(Lx,x), both parameters being appropriate as ambient illuminance Lx₌t. Here, x is the input gradation value, which is one of 256 levels ranging from 0 to 255 if the gradation value of each pixel is defined by eight bits. The panel luminance controller 101 inputs the panel luminance PL(Lx) to the peak luminance controller 105 and the display controller 41. The display controller 41 also inputs the gradation conversion γ(Lx,x) to the gradation conversion function calculation module 106.

The panel luminance PL(Lx) is a panel setting value for the display module 40 (e.g., an OLED display) that may attain white luminance (cd/m²) required at the present ambient illuminance Lx₌t. In most cases, the panel luminance is increased with the ambient illuminance Lx₌t in order to maintain the image appearance to the human eyes, regardless of the present ambient illuminance Lx₌t. On the other hand, the gradation conversion γ(Lx,x) accomplishes γ conversion in which the input gradation value x maintains the color appearance, regardless of the present ambient illuminance Lx₌t. To be more specific, the gradation conversion γ(Lx,x) is so set that the difference (for example, the Bertleson-Breneman effect) of color appearance depending on the ambient light may be corrected. Note that the Bertleson-Breneman effect is a phenomenon in which the same image appears to have a specific contrast in a dark place and a different contrast in a light place. The panel luminance PL(Lx) and the gradation conversion γ(Lx,x) have been set beforehand, by the method described in, for example, CIE Publication No. 159, “A colour appearance model for colour management systems: CIECAM02.” They are associated with illuminance Lx and accumulated in the panel luminance control parameter accumulation module 102.

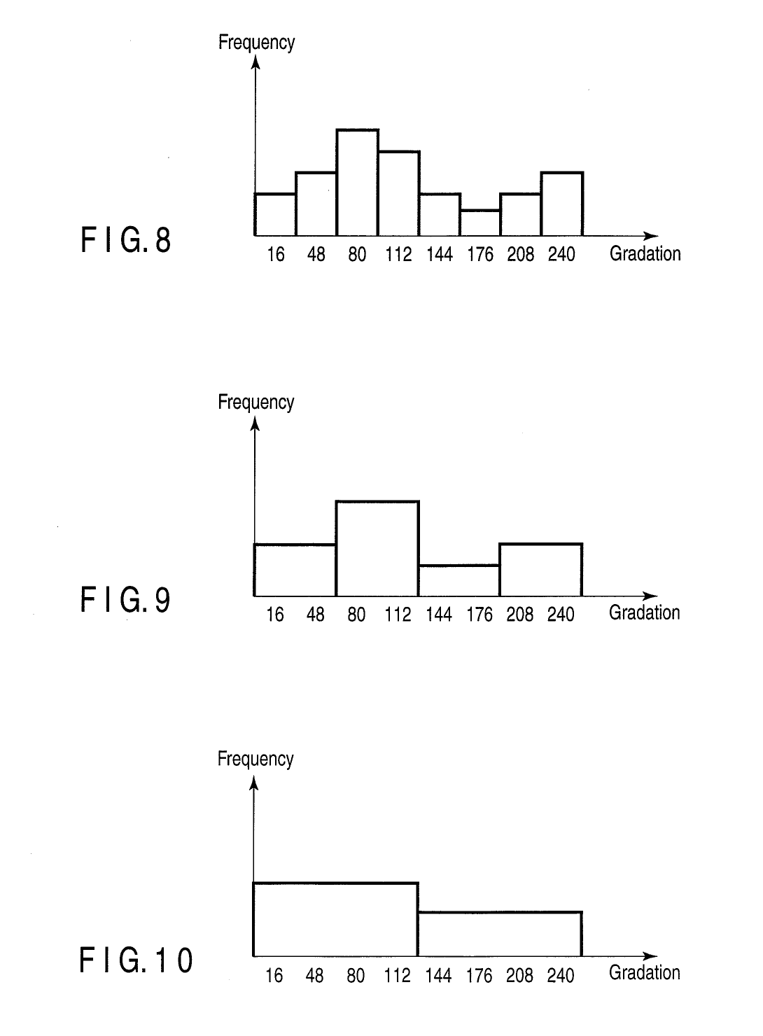

In Step S004, the histogram generator 103 generates a histogram of pixel gradation values for each frame of the decoded image (input image) input to the image processing apparatus 100a. The histogram generator 103 inputs the histogram, thus generated, to the APL calculation module 104. Pixel signals may be YUV format, RGB format or any other format. More precisely, the histogram generator 103 counts the pixels having gradation values that fall within each prescribed gradation range. The histogram generator 103 then generates a histogram in which the gradation values (representative gradation values) representing the respective gradation ranges are associated with the frequencies of gradation ranges (each frequency being the number of pixels counted for one gradation range). Thus, if the gradation range is “32,” the histogram generator 103 generates such a histogram as shown in FIG. 8. The gradation range is determined by the total number of gradation values and the rank of histogram. A gradation range of “32,” for example, is obtained by dividing the total number of gradation values, “256” by the rank of histogram, “8.” In the histogram of FIG. 8, the representative gradation values are plotted on the horizontal axis. Each representative gradation value may be the average of the gradation values falling within one gradation range or may be any other value.

The histogram generator 103 need not generate histograms for all components of pixel signals. It may generate a histogram for Y signals only if the pixel signals are of YUV format. It may generate a histogram of brightness only if the pixel signals are of RGB format. The brightness is equal to the largest gradation value any RGB component may have.

The broader the gradation range, the more the storage capacity needed to generate a histogram can be reduced. If the gradation range is “32,” the upper three of the eight bits can express a representative gradation value (In this case, the lower five bits can be fixed to “00000.”). If the gradation range is “1,” the representative gradation value is expressed by all eight bits. Note that Step S004 can be performed, independently of Steps S001 to S003.

The APL calculation module 104 calculates the average luminance (also called the average picture level [APL]) of the one-frame input image from the histogram generated in Step S004 (Step S005). More precisely, the APL calculation module 104 calculates APL from the histogram, in accordance with the following expression (1) or (2):

$$\begin{matrix}A P L = \frac{{\sum }_{i = 0}^{255} h ( i ) \cdot i}{{\sum }_{i = 0}^{255} h ( i )} & ( 1 ) \\ A P L = \frac{{\sum }_{i = 0}^{255} h ( i ) \cdot {( \frac{i}{255} )}^{2.2}}{{\sum }_{i = 0}^{255} h ( i )} & ( 2 )\end{matrix}$$

wherein h(i) is the histogram for gradation value i, which is 0 unless the gradation value i is equal to the representative gradation value.

If expression (1) is applied, the APL calculation module 104 will calculate APL that is the arithmetical mean of the gradation values obtained by converting the gradation values of the input image pixels to the representative gradation values. If expression (2) is applied, the APL calculation module 104 will calculate APL that is the arithmetical mean of the gradation values obtained by converting the gradation values of the input image pixels to representative gradation values and by normalizing the representative gradation values by performing γ conversion (γ=2.2). The APL calculation module 104 may calculate a characteristic amount other than APL, for example a central value. The characteristic amount should be one useful in determining whether the input image is a bright scene or a dark scene.

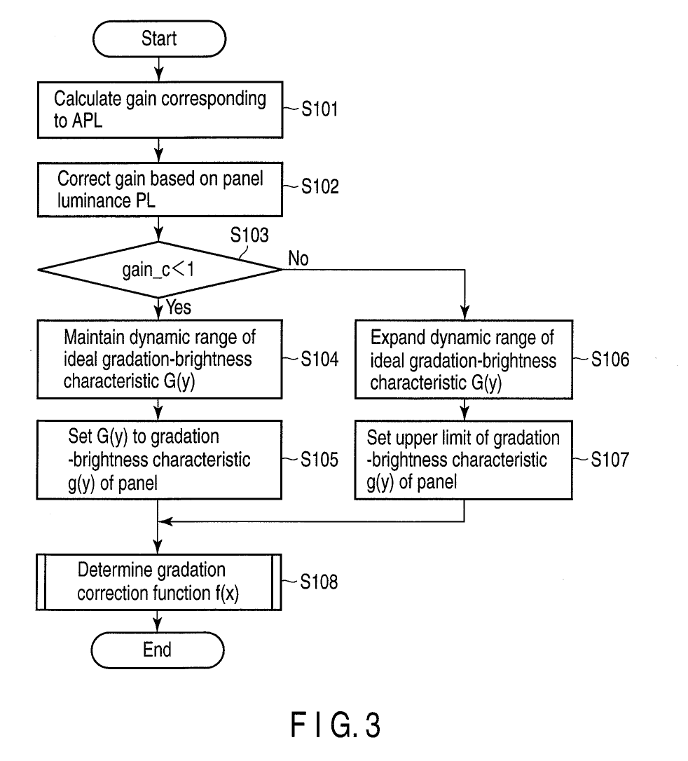

Then, the peak luminance controller 105 controls the peak luminance allocated to the input image (Step S006). Further, the gradation conversion function calculation module 106 calculates a gradation correction function f(x) (Step S006). The detailed description of the process performed in Step S006 will be explained later with reference to FIG. 3.

The gradation conversion function calculation module 106 uses the gradation correction function f(x) generated in Step S006 and the gradation conversion γ(Lx,x) generated in Step S003, generating a gradation conversion function F(x) in accordance with the following expression (3) (Step S007):

F(x)=γ(Lx,f(x)) (3)

The gradation conversion function calculation module 106 stores the gradation conversion function F(x) in the gradation conversion LUT storage module 107. In the gradation conversion LUT storage module 107, the gradation conversion function F(x) is stored in association with the input gradation value x.

Next, the image conversion module 108 uses the gradation conversion function F(x) calculated in Step S007, converting the gradation values of the pixels forming the input image, and thereby generates a gradation-converted image (Step S008). The image conversion module 108 inputs the gradation-converted image, as display image data, to the display controller 41. To be more specific, the image conversion module 108 first acquires the gradation-converted values corresponding to the gradation values of the input image pixels, from the gradation conversion LUT storage module 107. The display controller 41 then sets the panel setting value acquired in Step S003, to the display module 40 in synchronism with the timing of displaying the gradation-converted image (Step S009). Thus, the process shown in FIG. 2 is terminated.

Step S006 shown in FIG. 2 will now be explained in detail with reference to FIG. 3.

In Step S101, the peak luminance controller 105 calculates a gain corresponding to APL calculated in Step S004. The gain is a ratio by which to control the peak luminance and the dynamic range of ideal panel characteristics, and is corrected in Step S102 as will be explained later. More specifically, the peak luminance controller 105 calculates a gain corresponding to APL, based on such a relation with APL as shown in FIG. 7. The relation shown in FIG. 7 is no more than an example. This relation may be a combination of linear functions as illustrated in FIG. 7. Alternatively, it may be expressed by a function modeled by use of Gaussian distribution. The peak luminance controller 105 holds this relation as a lookup table (LUT), and the LUT may be referred to, thereby to calculate the gain. Alternatively, a function corresponding to the above-mentioned relation may be applied to APL, thereby to calculate the gain. It is desired that the peak luminance controller 105 should calculate a gain greater than or equal to 1 in order to enhance the gradation appearance if the input image corresponds to a dark scene (has a low APL), and should calculate a gain less than 1 in order to decrease current consumption if the input image corresponds to a bright scene (has a high APL). Nonetheless, the peak luminance controller 105 may calculate a gain less than 1 for a dark scene to achieve an object other than an enhancement in the gradation appearance, or a gain greater than or equal to 1 for a bright scene to achieve an object other than a decrease in the current consumption.

Next, the peak luminance controller 105 corrects the gain calculated in Step S101, on the basis of the panel luminance PL(Lx) acquired in Step S003 (Step S102).

The technical significance of the gain correction will be explained below.

The current a self-emission type device, such as an OLED display, consumes to display an image of a specific gradation value changes depending on the panel luminance. That is, the more the white luminance is lowered by suppressing the panel luminance, the more the current consumption can be reduced. Assume that a gradation correcting function is calculated, which may reduce the power consumption at the panel, by a specific ratio, by suppressing the peak luminance. Then, if the panel luminance is high and the power consumption is therefore relatively large, the gradation correcting function will greatly reduce the power consumption. On the other hand, if the panel luminance is low and the power consumption is therefore relatively small, the gradation correcting function will reduce the power consumption, but only a little. In other words, if the panel luminance is low, the power consumption will be small, and the suppression of peak luminance will not reduce the power consumption as much as expected.

Human eyes are known to perceive brightness in proportion to ⅓ power to the light intensity (cd/m²). That is, man is more sensitive to brightness changes at low gradation, than to brightness changes at high gradation. Assume that a gradation correcting function is calculated, which may suppress the peak luminance by a particular ratio. Then, the brightness deterioration caused by using this gradation correcting function is relatively small if the panel luminance is high, and is relatively large if the panel luminance is low.

Thus, if the panel luminance is high (the panel is bright), the peak luminance should better be suppressed in order to reduce the power consumption and to maintain the image brightness. Conversely, if the panel luminance is low (the panel is dark), it is not always advisable to suppress the peak luminance in order to reduce the power consumption and to maintain the image brightness. This is why the peak luminance controller 105 corrects the gain determined by APL, to gain_c that monotonically decreases as the panel luminance PL(Lx) increases.

More specifically, the peak luminance controller 105 calculates gain (gain_l) for dark environment, in accordance with the following expression (4):

gain_{—}l=max(gain,1) (4)

In expression (4), gain_l is substituted by the gain calculated in Step S101 or “1,” which is greater than the other. The peak luminance controller 105 may calculate gain_l, by a method other than the method based on expression (4). Further, the peak luminance controller 105 calculates corrected gain (gain_c) in accordance with the following expression (5):

$$gain\_c = \{ \begin{matrix}\begin{matrix}\begin{matrix}if ( Cd ( PL ) < Cd ( PL\_l ) ) gain\_l \\ else if ( Cd ( PL\_h ) < Cd ( PL ) ) gain\end{matrix} \\ else \frac{\{ Cd ( PL ) - Cd ( PL\_l ) \} * gain}{Cd ( PL\_h ) - Cd ( PL\_l )} +\end{matrix} \\ \frac{\{ Cd ( PL\_h ) - Cd ( PL ) \} * gain\_l}{Cd ( PL\_h ) - Cd ( PL\_l )}\end{matrix} \qquad ( 5 )$$

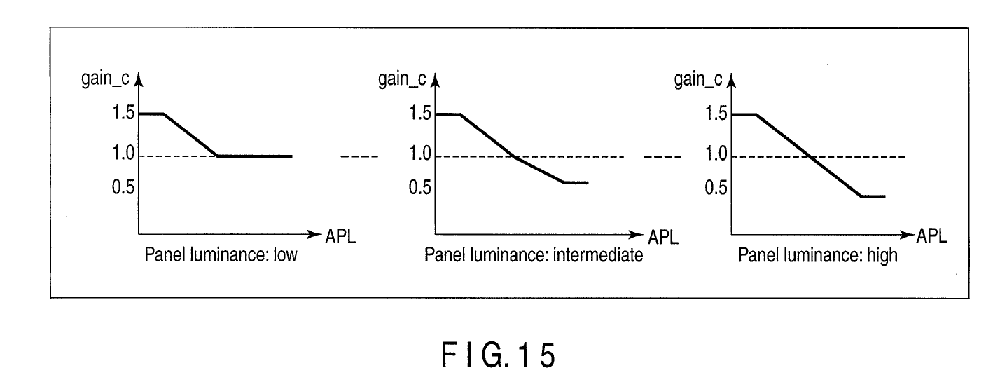

In expression (5), PL is substituted by the panel luminance PL(Lx) acquired in Step S003. PL_h is a threshold value for use in determining a bright environment, and PL_l is a threshold value for determining a dark environment. As described above, the panel luminance is designed to increase with the ambient illuminance. Therefore, the term “intensity of ambient light” (bright or dark) will be used in the same or similar sense as “panel luminance” (bright or dark), hereinafter. That is, a “bright environment” is an environment where the panel luminance is high, and a “dark environment” is an environment where the panel luminance is low. In expression (5), Cd(PL) is the white luminance achieved at panel luminance PL. In expression (5), white luminance is used, setting a condition branch. Instead, the panel luminance may be used to set the condition branch. That is, “if (Cd(PL)<Cd(PL_l))” may be written to “if (PL<PL_l),” and “if Cd(PL_h)<Cd(PL))” may be written to “if(PL_h<PL).” Expression (5) expresses corrected gains (gain_c), for a dark environment, a normal environment (neither dark nor bright), and a bright environment, respectively. More precisely, the gain_c is gain_l in the dark environment, and is gain (not corrected) in the bright environment. In the normal environment, the gain_c is calculated by performing linear interpolation on the gain and the gain_l. FIG. 15 represents the relations APL and the gain_c calculated in accordance with expression (5). In FIG. 15, three corrected gains (gain_c) for a dark environment, a normal environment and a bright environment, respectively, from the left to the right in the order mentioned. Any gain_c may be calculated by any method other than the method of expression (5). For example, it may be calculated from a function modeled by use of Gaussian distribution.

The peak luminance controller 105 uses the gain_c, calculating the peak luminance Yₚₑₐₖ in accordance with the following expression (6):

Yₚₑₐₖ=INT(clip(gain_{—}c·255,255)) (6)

In expression (6), clip(a,b) is a clip function in which a is returned if a is less b, or b is returned if a is greater than or equal to b, and INT( ) is a rounding function for integer number. That is, if the gain_c is less than “1,” the peak luminance Yₚₑₐₖ is a value obtained by rounding off the product of gain_c and “255.” If the gain_c is greater than or equal to “1,” the peak luminance Yₚₑₐₖ is “255.” The peak luminance controller 105 inputs the gain_c and the peak luminance Yₚₑₐₖ to the gradation conversion function calculation module 106.

The gradation conversion function calculation module 106 then determines whether the gain_c is less than “1” (Step S103). If gain_c is less than “1,” the process goes to Step S104. Otherwise, the process goes to Step S106.

In Step S104, the gradation conversion function calculation module 106 defines the ideal gradation-brightness characteristic G(y) of the display module 40, in accordance with the following expression (7):

$$G ( y ) = {( \frac{y}{255} )}^{2.2} \qquad ( 7 )$$

In the right side of expression (7), the ideal brightness corresponding to the eight-bit gradation value y is normalized on the assumption that the maximum brightness the display module 40 can reproduce is “1.0.” The gradation conversion function calculation module 106 may hold the right side of expression (7) in the form of, for example, an LUT.

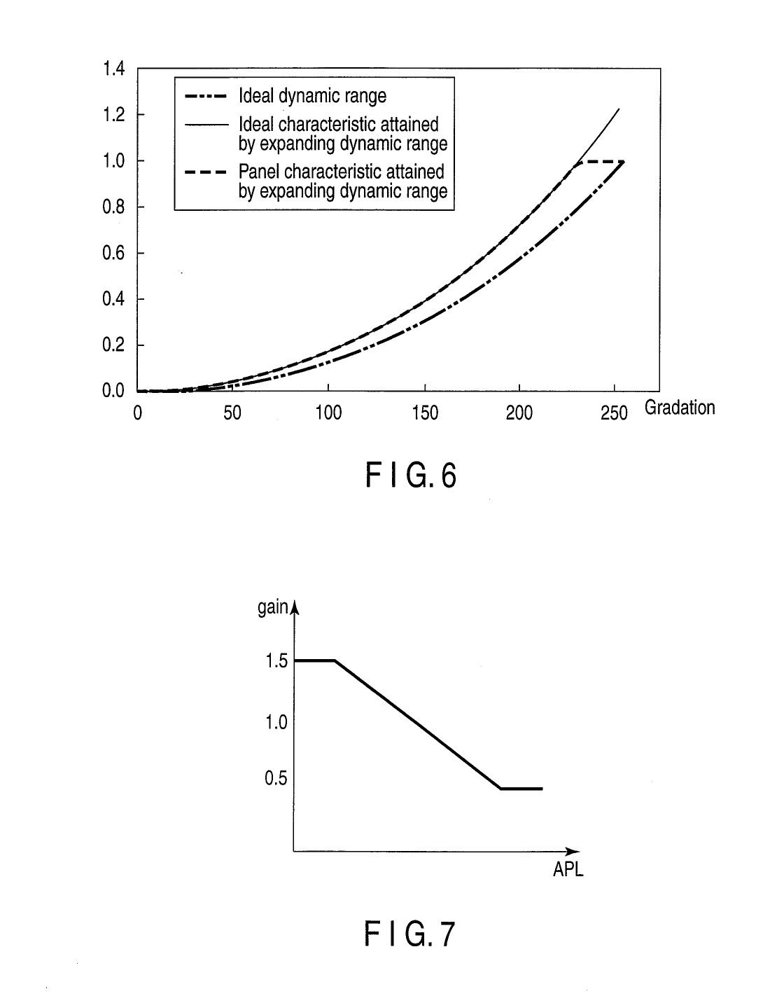

That is, the gradation conversion function calculation module 106 may maintain the dynamic range expressed by the right side of expression (7). The two-dot dashed line shown in FIG. 6 indicates the gradation-brightness characteristic G(y). The gradation conversion function calculation module 106 may not utilize the gradation-brightness characteristic G(y), but utilize the gradation-lightness characteristic G_{L}*(y) that pertains to the lightness defined in a uniform color space. The relation between the gradation-lightness characteristic G_{L}*(y) and the gradation-brightness characteristic G(y) is expressed by the following expression (8):

G_{L}*(y)=G(y)^{1/3} (8)

The gradation conversion function calculation module 106 may hold expression (8) in the form of, for example, an LUT.

The gradation conversion function calculation module 106 sets the ideal gradation-brightness characteristic G(y) to the gradation-brightness characteristic g(y) of the display module 40, as shown in the following expression (9) (Step S105).

g(y)=G(y) (9)

Then, the process goes to Step S108. As described above, the ideal gradation-brightness characteristic G(y) maintains the dynamic range expressed by the right side of expression (7). The display module 40 can therefore reproduce all brightness levels G(y) that correspond to the input gradation y.

The gradation conversion function calculation module 106 may not set the gradation-brightness characteristic g(y) of the display module 40, but set the gradation-lightness characteristic g_{L}*(y), in accordance with the following expression (10):

g_{L}*(y)=G_{L}*(y) (10)

In Step S106, the gradation conversion function calculation module 106 defines the ideal gradation-brightness characteristic G(y) of the display module 40, as expressed in the following expression (11):

$$G ( y ) = gain\_c \cdot {( \frac{y}{255} )}^{2.2} \qquad ( 11 )$$

That is, the gradation conversion function calculation module 106 multiplies the dynamic range, i.e., right side of expression (7), by the gain_c. In FIG. 6, the solid line indicates the ideal gradation-brightness characteristic G(y). As is clear from FIG. 6, this characteristic G(y) includes brightness (higher than “1.0”) the display module 40 cannot reproduce.

The gradation conversion function calculation module 106 may not utilize the gradation-brightness characteristic G(y), but utilize the gradation-lightness characteristic G_{L}*(y). The gradation conversion function calculation module 106 can define the gradation-lightness characteristic G_{L}*(y), as expressed in the following expression (12):

$${G}_{{L}^{*}} ( y ) = gain\_c \cdot {\{ {( \frac{y}{255} )}^{2.2} \}}^{1 / 3} \qquad ( 12 )$$

In Step S107, the gradation conversion function calculation module 106 sets the ideal gradation-brightness characteristic G(y) (not exceeding a prescribed upper limit) to the gradation-brightness characteristic g(y) of the display module 40, as indicated by the following expression (13):

g(y)=clip(G(y),1.0) (13)

Then, the process goes to Step S108. As indicated above, the ideal gradation-brightness characteristic G(y) has been attained by expanding the dynamic range, i.e., the right side of expression (7). Therefore, the characteristic G(y) includes brightness the display module 40 cannot reproduce.

As seen from expression (13), G(y) is set to the gradation-brightness characteristic g(y) of the display module 40 if the brightness G(y) corresponding to y is less than “1.0,” and “1.0” is set to the gradation-brightness characteristic g(y) if the brightness G(y) corresponding to y is greater than or equal to “1.0.” This gradation-brightness characteristic g(y) is indicated by the broken line In FIG. 6. The gradation conversion function calculation module 106 may set the gradation-lightness characteristic g_{L}*(y), not the gradation-brightness characteristic g(y) of the display module 40, in accordance with the following expression (14):

g_{L}*(y)=clip(G_{L}*(y),1.0) (14)

In Step S108, the gradation conversion function calculation module 106 determines the gradation correction function f(x) from the ideal gradation-brightness characteristic G(y), the gradation-brightness characteristic g(y) of the display module 40 and the histogram generated in Step S004. At this point, the process of FIG. 3 is terminated. Note that the ideal gradation-brightness characteristic G(y) and the gradation-lightness characteristic G_{L}*(y) may be referred to as ideal panel characteristics. Further, the gradation-brightness characteristic g(y) and the gradation-lightness characteristic G_{L}*(y) may be referred to as the panel characteristics of the display module 40. The gradation conversion function calculation module 106 initializes the gradation correction function f(x), with f(0)=0 and f(255)=peak luminance Yₚₑₐₖ. Further, the gradation conversion function calculation module 106 performs linear interpolation using f(0) and f(255), initializing f(1) to f(254).

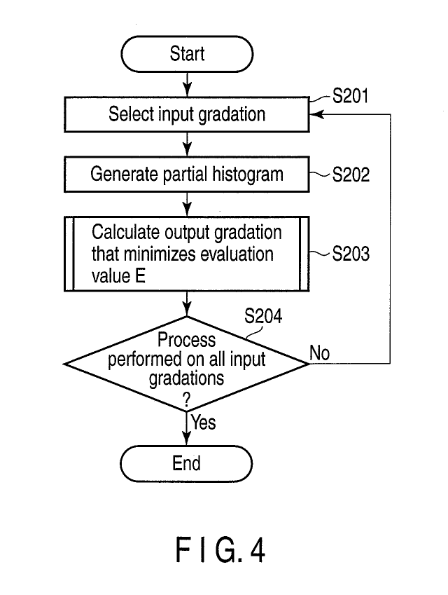

The process performed in Step S108 (FIG. 3) will be explained in detail, with reference to FIG. 4.

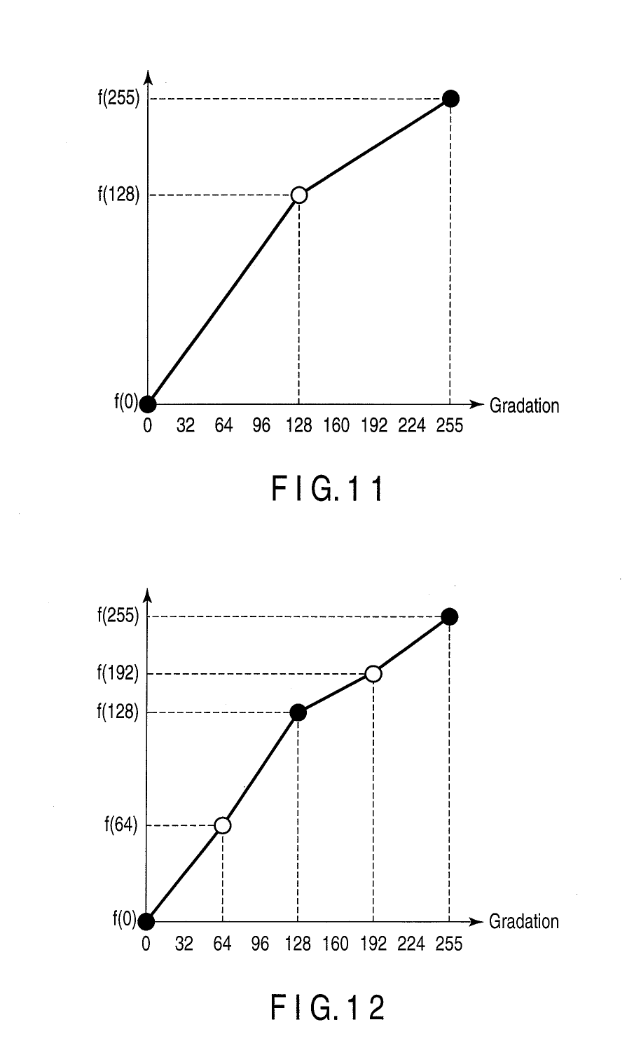

In Step S201, the gradation conversion function calculation module 106 selects input gradation Xt. The input gradation Xt selected is, for example, the representative gradation value of the histogram generated in Step S004. The gradation conversion function calculation module 106 may first select, as input gradation Xt, “128” intermediate between “0” and “255” (see FIG. 11), and may then select, as input gradation Xt, “64” intermediate between “0” and “128,” or “192” intermediate between “128” and “256” (see FIG. 12).

Thus, the gradation conversion function calculation module 106 selects various input gradation values Xt, and obtains output gradation values Y that minimize an evaluation value E (described later) in the process of FIG. 4. The gradation conversion function calculation module 106 then determines f(Xt)=Y. It is desired that the input gradation values Xt be discrete ones, so that the process load may be reduced. The gradation conversion function calculation module 106 can calculate an output gradation value from any input gradation value not selected as input gradation Xt, by performing linear interpolation on the output gradation values Y already calculated. The gradation conversion function calculation module 106 may, of course, select all input gradation values as input gradations Xt in the process of FIG. 4.

Next, the gradation conversion function calculation module 106 generates a partial histogram with respect to the input gradation Xt selected in Step S201 (Step S202). More precisely, the gradation conversion function calculation module 106 generates the partial histogram for the range between input gradations X0 and X1 that precedes and follows the input gradation Xt, respectively. The input gradations X0 and X1 are already processed. The partial histogram includes a frequency of gradation range from the minimum gradation X0 to gradation less than input gradation Xt, and a frequency of gradation range from the input gradation Xt to gradation less than the maximum gradation X1. If the input gradation Xt=“128,” the gradation conversion function calculation module 106 generates a partial histogram between two processed input gradations X0=“0” and X1=“255,” which precedes and follows the input gradation Xt, respectively, in accordance with the following expression (15) (see FIG. 10)

$$\begin{matrix}H ( 0 , 127 ) = {\sum }_{i = 0}^{127} h ( i ) & ( 15 ) \\ H ( 128 , 255 ) = {\sum }_{i = 128}^{255} h ( i ) & \end{matrix}$$

If the input gradation Xt=“64” or “192,” the gradation conversion function calculation module 106 generates a partial histogram between two processed input gradations X0=“0” and X1=“128,” which precedes and follows the input gradation Xt, respectively, or a partial histogram between two processed input gradations “128” and “256,” which precedes and follows the input gradation Xt, respectively (see FIG. 9)

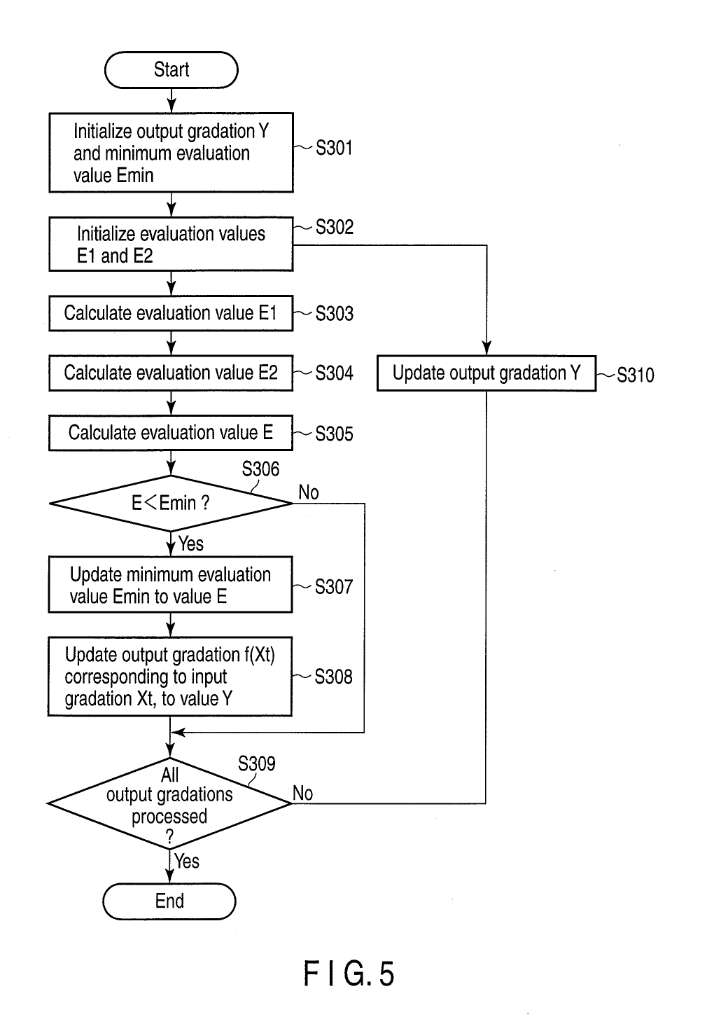

The gradation conversion function calculation module 106 calculates output gradation Y that minimizes the evaluation value E based on the partial histogram generated in Step S202 (Step S203). The process performed in Step S203 will be later described in detail, with reference to FIG. 5. The gradation conversion function calculation module 106 then determines whether the process has been performed on all input gradations Xt (Step S204). If all input gradations Xt have been processed, the process of FIG. 4 is terminated. Otherwise, the process returns to Step S201.

The process performed in Step S203 (FIG. 4) will now be described in detail, with reference to FIG. 5.

In Step S301, the gradation conversion function calculation module 106 initializes the output gradation Y and the minimum evaluation value Emin in accordance with the following expression (16):

Y=f(X0)

Eₘᵢₙ=MAX_VAL (16)

wherein MAX_VAL is much greater than Emin.

The process then goes to Step S302. In Step S302, the gradation conversion function calculation module 106 initializes evaluation values E1 and E2 as is expressed in the following expression (17):

E1=0 (16)

E2=0 (17)

Next, the gradation conversion function calculation module 106 calculates evaluation value E1 (Step S303). To be more specific, the gradation conversion function calculation module 106 calculates this value E1 in accordance with the following expression (18), expression (19) or expression (20):

E1=|G(Xt)−g(Y)|·(H(X0,Xt−1)+H(Xt,X1)) (18)

E1={G(Xt)−g(Y)}²·(H(X0,Xt−1)+H(Xt,X1)) (19)

E1={G_{L}*(Xt)−g_{L}*(Y)}²·(H(X0,Xt−1)+H(Xt,X1)) (20)

According to expression (18), the evaluation value E1 may be obtained by multiplying the absolute difference between ideal brightness G(Xt) corresponding to the input gradation Xt and the brightness g(Y) of the display module 40, which corresponds to the output gradation Y, by the sum of the histograms generated in Step S202.

According to expression (19), the evaluation value E1 may alternatively be obtained by multiplying the squared difference between ideal brightness G(Xt) corresponding to the input gradation Xt and the brightness g(Y) of the display module 40, which corresponds to the output gradation Y, by the sum of the histograms generated in Step S202.

According to expression (20), the evaluation value E1 may still alternatively be obtained by multiplying the squared difference between ideal lightness G_{L}*(Xt) corresponding to the input gradation Xt and the lightness g_{L}*(y) of the display module 40, which corresponds to the output gradation Y, by the sum of the histograms generated in Step S202.

Further, the gradation conversion function calculation module 106 calculates evaluation value E2 (Step S304). Step S303 and Step S304 may be performed in the reverse order, or in parallel. More precisely, the gradation conversion function calculation module 106 calculates gradient ΔG(X0,Xt) and gradient ΔG(Xt,X1), both pertaining to the input gradation Xt, in accordance with the following expression (21):

ΔG(X0,Xt)=G(Xt)−G(X0)

ΔG(Xt,X1)=G(X1)−G(Xt) (21)

As seen from expression (21), the gradient ΔG (X0,Xt) is a value obtained by subtracting ideal brightness G(X0) corresponding to the minimum gradation X0, from the ideal brightness G(Xt) corresponding to the input gradation Xt; and the gradient ΔG(Xt,X0) is a value obtained by subtracting ideal brightness G(Xt) corresponding to the input gradation Xt, from the ideal brightness G(X1) corresponding to the maximum gradation X1. Note that expression (21) may be rewritten with respect to the ideal gradation-lightness characteristic G_{L}*(x).

Further, the gradation conversion function calculation module 106 calculates gradient Δg(f(X0),Y) and gradient Δg(Y,f(X1)), both pertaining to the input gradation Xt, in accordance with the following expression (22):

Δg(f(X0),Y)=g(Y)−g(f(X0))

Δg(Y,f(X1))=g(f(X1))−g(Y) (22)

As seen from expression (22), the gradient Δg(f(X0),Y) is a value obtained by subtracting the brightness g(X0) of the display module 40, which corresponds to the output gradation f(X0), from the brightness g(Y) of the display module 40, which corresponds to the output gradation Y; and the gradient Δg(Y,f(X1)) is a value obtained by subtracting the brightness g(Y) of the display module 40, which corresponds to the output gradation Y, from the brightness g(f(X1)) of the display module 40, which corresponds to the output gradation f(X1). Note that expression (22) may be rewritten with respect to the gradation-lightness characteristic g_{L}*(x) of the display module 40.

Next, the gradation conversion function calculation module 106 calculates the evaluation value E2 in accordance with the following expression (23), expression (24) or expression (25):

E2=|ΔG(X0,Xt)−Δg(f(X0),Y)|·H(X0,Xt−1)+|ΔG(Xt,X1)−Δg(Y,f(X1))|·H(Xt,X1) (23)

E2={ΔG(X0,Xt)−Δg(f(X0),Y)}²·H(X0,Xt−1)+{ΔG(Xt,X1)−Δg(Y,f(X1))}²·H(Xt,X1) (24)

E2={ΔG_{L}*(X0,Xt)−Δg_{L}*(f(X0),Y)}₂·H(X0,Xt−1)+{ΔG_{L}*(Xt,X1)−Δg_{L}*(Y,f(X1))}²·H(Xt,X1) (25)

According to expression (23), the evaluation value E2 is the sum of two values. One of these values has been obtained by multiplying the absolute difference between gradient ΔG(X0,Xt) and gradient Δg(f(X0),Y), by the frequency H(X0,Xt-1) of a gradation range from the minimum gradation X0 to gradation less than the input gradation Xt. The other of the values has been obtained by multiplying the absolute difference between gradient ΔG(Xt,X1) and gradient Δg(Y,f(X1)), by the frequency H(Xt,X1) of a gradation range from the input gradation Xt to gradation less than the maximum gradation X1.

According to expression (24), the evaluation value E2 is the sum of two values. One of these values has been obtained by multiplying the square difference between gradient ΔG(X0,Xt) and gradient Δg(f(X0),Y), by the frequency H(X0,Xt-1) of a gradation range from the minimum gradation X0 to gradation less than the input gradation Xt. The other of the values has been obtained by multiplying the square difference between gradient ΔG(Xt,X1) and gradient Δg(Y,f(X1)), by the frequency H(Xt,X1) of a gradation range from the input gradation Xt to gradation less than the maximum gradation X1.

According to expression (25), the evaluation value E2 is the sum of two values. One of these values has been obtained by multiplying the square difference between gradient ΔG_{L}*(X0,Xt) and gradient Δg_{L}*(f(X0),Y), by the frequency H(X0,Xt-1) of a gradation range from the minimum gradation X0 to gradation less than the input gradation Xt. The other of the values has been obtained by multiplying the square difference between gradient ΔG_{L}*(Xt,X1) and gradient Δg_{L}*(Y,f(X1)), by the frequency H(Xt,X1) of a gradation range from the input gradation Xt to gradation less than the maximum gradation X1.

Then, in Step S305, the gradation conversion function calculation module 106 calculates evaluation value E from the evaluation values E1 and E2 calculated in Steps S303 and S304, respectively, in accordance with the following equation (26):

E=λ·E1+(1−λ)·E2 (26)

where λ is a weight coefficient ranging from 0 to 1.

Further, the gradation conversion function calculation module 106 compares the evaluation value E calculated in Step S305 with the minimum evaluation value Emin at the time in Step S305 (Step S306). If the evaluation value E is smaller than the minimum evaluation value Emin, the process goes to Step S307. Otherwise, the process jumps to Step S309.

In Step S307, the gradation conversion function calculation module 106 updates the minimum evaluation value Emin to the evaluation value E calculated in Step S305. The gradation conversion function calculation module 106 then updates the output gradation f(Xt) corresponding to the evaluation value E to value Y (Step S308). The process then goes to Step S309.

In Step S309, the gradation conversion function calculation module 106 determines whether all output gradations have been processed or not. If all output gradations have been processed, the process of FIG. 5 is terminated. Otherwise, the process goes to Step S310. Note that f(X1) or a similar value, for example, may be set as the upper limit for the output gradation Y. In Step S310, the gradation conversion function calculation module 106 updates the output gradation Y (incrementing the gradation Y by, for example, “1”). Then, the process returns to Step S301.

In a dark scene wherein APL is low and the gain_c is 1 or greater, the dynamic range of ideal panel characteristic is expanded on the basis of the gain_c. Based on the ideal panel characteristic, whose dynamic range has thus been expanded, and the histogram, a gradation correction function f(x) is calculated. The gradation conversion function F(x) applies gradation conversion that accords with the panel luminance, to the gradation corrected value f(x) that corresponds to the input gradation value x. Therefore, the gradation-converted image appears brighter than in the case where the input gradation value x undergoes the above-mentioned gradation conversion, and the gradation appearance increases, not impaired at all.

In a bright scene wherein APL is high and the gain_c is less than 1, the gain_c suppresses the peak luminance Yₚₑₐₖ. From the peak luminance Yₚₑₐₖ suppressed, ideal panel characteristic and histogram, the gradation correction function f(x) is calculated. More specifically, the gradation correction function f(x) restores the contrast of ideal panel characteristic in precedence, at a highly frequent gradation. The gradation conversion function F(x) applies gradation conversion that accords with the panel luminance, to the gradation-corrected value f(x) correspond to the input gradation value x. Therefore, the image undergone the gradation conversion has contrast not so decreased as in the case where the gradation conversion is applied to the input gradation value x, and the power consumption can yet be reduced.

The image processing apparatus 100a according to this embodiment uses the corrected gain (gain_{—c}), controlling the dynamic range of ideal panel characteristic and the peak luminance Yₚₑₐₖ. The gain_c has been obtained by correcting the gain determined by APL to a value that monotonically decreases as the panel luminance increases. As a result, the peak luminance Yₚₑₐₖ is suppressed to display a bright scene in a bright environment (at high panel luminance). To display a dark scene in a dark environment (at low panel luminance), the dynamic range of ideal panel characteristic is expanded. That is, if a bright scene is displayed at high panel luminance, the peak luminance Yₚₑₐₖ is suppressed, decreasing the power consumption. On the other hand, if a dark scene is displayed at low panel luminance, the dynamic range of ideal panel characteristic is expanded, maintaining the high gradation appearance is maintained. With respect to given APL, the higher the panel luminance, the more the power consumption should be reduced, and the lower the panel luminance, the more the gradation appearance should be enhanced. With respect to given panel luminance, the higher the APL, the more the power consumption should be reduced, and the lower the APL, the more the gradation appearance should be enhanced. Hence, the image processing apparatus 100a can accomplish effective image processing that accords with the human visual sensation and the current consumption of any self-emission type device.

As has been explained, the image processing apparatus according to the first embodiment performs image processing in accordance with the intensity of ambient light and the characteristic amount of the input image. More precisely, the image processing apparatus is so designed to reduce the power consumption in order to display a bright scene in a bright environment and to enhance the gradation appearance in order to display a dark scene in a dark environment. Hence, the image processing apparatus according to this embodiment can prevent the subjective image quality from degrading, while suppressing the current consumption of the display module.

### Second Embodiment

An image processing apparatus 100a according to a second embodiment will be described with reference to FIG. 14. As shown in FIG. 14, this image processing apparatus 100a has a panel luminance controller 101, a panel luminance control parameter accumulation module 102, a histogram generator 103, an APL calculation module 104, a gradation conversion function calculation module 200, a peak luminance gain parameter accumulation module 201, a gradation conversion LUT storage module 107, and an image conversion module 108. The components identical to those of the first embodiment shown in FIG. 13 are designated by the same reference numbers. The components differing from the second embodiment will be described in the main.

The gradation conversion function calculation module 200 receives APL from the APL calculation module 104, and gradation conversion γ(Lx,x) and panel luminance PL(Lx) from the panel luminance controller 101. The peak luminance gain parameter accumulation module 201 holds a two-dimensional LUT storing the corrected gain (gain_c) corresponding to the APL and panel luminance PL(Lx). The two-dimensional LUT may be prepared beforehand offline. The gradation conversion function calculation module 200 acquires the gain_c corresponding to the APL and panel luminance PL(Lx), from the peak luminance gain parameter accumulation module 201. Therefore, the gradation conversion function calculation module 200 can derive the gain_c corresponding to the APL and panel luminance PL(Lx), within a shorter time than the peak luminance controller 105 does in the first embodiment. The gradation conversion function calculation module 200 uses the gain_{—c}, calculating gradation conversion function F(x).

As has been described, the image processing apparatus according to the second embodiment uses a two-dimensional LUT storing the corrected gain (gain_c) corresponding to the APL and panel luminance PL(Lx), thereby acquiring the gain_c corresponding to the input panel luminance parameter. Therefore, the image processing apparatus according to this embodiment can obtain the gain_c in a shorter time than in the first embodiment. Hence, it can complete the sequence of an image processing within a short time.

For example, each embodiment described above may incorporate a computer-readable storage medium that stores the program for achieving the processing described above. The storage medium can be of any type that is readable by a computer and is able to hold program data, such as a magnetic disk, an optical disc (e.g., CD-ROM, CD-R, DVD, etc.) and, an magneto-optical disk (e.g., MO), or a semiconductor memory. Moreover, the program data for achieving the processing may be downloaded to a computer (client) via, for example, the Internet, from a computer (server) connected to the network.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a panel luminance controller configured to control panel luminance of a self-emission-type device based on intensity of ambient light;
a calculator configured to calculate a gradation conversion function for changing the appearance of an input image, wherein the gradation conversion function is based on the panel luminance and a factor relating to the brightness or darkness of the input image; and
a converter configured to apply the gradation conversion function to the input image, to generate an output image.

2. The apparatus of claim 1,
wherein the panel luminance controller is configured to set a gradation conversion parameter based on the intensity of the ambient light and an input gradation value and corresponding to the panel luminance; and
wherein the calculator is configured to calculate a gradation correction function for correcting the input gradation value based on the panel luminance and a factor relating to the brightness or darkness of the input image, and further configured to calculate the gradation conversion function based on the corrected input gradation value.

3. The apparatus of claim 2, wherein the calculator is configured to calculate, based on the panel luminance, a second gain by correcting a first gain corresponding to the factor relating to the brightness or darkness of the input image, and to calculate the gradation correction function based on the second gain.

4. The apparatus of claim 3, wherein the second gain is a value that monotonically decreases as the panel luminance increases.

5. The apparatus of claim 3, wherein the second gain is a value greater than or equal to the first gain when the panel luminance is a value smaller than a first threshold value, is a value ranging from the first gain to the prescribed value when the panel luminance ranges from the first threshold value to a second threshold value greater than the first threshold value, and is equal to the first gain when the panel luminance is greater than or equal to the second threshold value.

6. The apparatus of claim 5, wherein the prescribed value is equal to the first gain when the first gain is greater than or equal to 1, and is equal to 1 when the first gain is less than 1.

7. The apparatus of claim 3, wherein the factor relating to the brightness or darkness of the input image is an index indicating brightness of a scene of the input image, and the first gain is a value that monotonically decreases as the brightness of the scene increases.

8. An image processing apparatus comprising:
a panel luminance controller configured to
control panel luminance of a self-emission type device based on intensity of ambient light, and
set a gradation conversion parameter based on the intensity of the ambient light and an input gradation value and corresponding to the panel luminance;
a calculator configured to
calculate peak luminance to allocate to an input image, based on the panel luminance and a factor relating to the brightness or darkness of the input image,
calculate a gradation correction function for correcting the input gradation value to a value less than or equal to the peak luminance, and
calculate a gradation conversion function based on the corrected input gradation value; and
a converter configured to apply the gradation conversion function to the input image, to generate an output image.

9. The apparatus of claim 8, wherein the calculator is configured to calculate a second gain by correcting a first gain corresponding to the factor relating to the brightness or darkness of the input image based on the panel luminance, and to calculate the peak luminance based on the second gain.

10. The apparatus of claim 9, wherein the second gain is a value that monotonically decreases as the panel luminance increases.

11. The apparatus of claim 9, wherein the second gain is a prescribed value greater than or equal to the first gain when the panel luminance is a value smaller than a first threshold value, is a value ranging from the first gain to the prescribed value when the panel luminance ranges from the first threshold value to a second threshold value greater than the first threshold, and is equal to the first gain when the panel luminance is greater than or equal to the second threshold value.

12. The apparatus of claim 11, wherein the prescribed value is equal to the first gain when the first gain is greater than or equal to 1, and is equal to 1 when the first gain is less than 1.

13. The apparatus of claim 9, wherein the calculator is configured to calculate, as the peak luminance, an upper limit of the input gradation value when the second gain is greater than or equal to 1, and calculate, as the peak luminance, a product of the second gain and the upper limit of the input gradation value when the second gain is less than 1.

14. The apparatus of claim 9, wherein the factor relating to the brightness or darkness of the input image is an index indicating brightness of a scene of the input image, and the first gain is a value that monotonically decreases as the brightness of the scene increases.
